(19) United States
(12) Patent Application Publication
(10) Pub. No.: US 2025/0246722 A1
(43) Pub. Date: Jul. 31, 2025

(54) BATTERY ASSEMBLY AND ASSEMBLING METHOD OF THE SAME

(71) Applicant: SK On Co., Ltd., Seoul (KR)

(72) Inventor: Kyu Hyun HAN, Daejeon (KR)

(21) Appl. No.: 19/035,859

(22) Filed: Jan. 24, 2025

(30) Foreign Application Priority Data
Jan. 31, 2024 (KR) 10-2024-0015034

(51) Int. Cl. H01M 10/658; H01M 10/647; H01M 50/143; H01M 50/172; H01M 50/505

(52) U.S. Cl. CPC H01M 10/658; H01M 10/647; H01M 50/143; H01M 50/172; H01M 50/505

(57) ABSTRACT

The present disclosure relates to a battery assembly including a plurality of battery cells staked and arranged in a predetermined stacking direction, an accommodation case accommodating the plurality of battery cells, an insertion space formed between the plurality of battery cells and the accommodation case in the stacking direction, and an insertion member located in the insertion space, wherein the insertion member includes a support body forming the buffer space, and a rib portion dividing the buffer space into a plurality of divided spaces.

### CROSS-REFERENCE TO RELATED PATENT APPLICATION

The present application claims priority under 35 U.S.C. § 119(a) to Korean patent application number 10-2024-0015034 filed on Jan. 31, 2024, the entire disclosure of which is incorporated by reference herein.

### BACKGROUND

### 1. Field

The present disclosure relates to a battery assembly and an assembling method of the battery assembly, and more particularly, to a battery assembly for delaying thermal propagation (TP) during thermal runaway of a battery cell, and a method of manufacturing the battery assembly.

### 2. Description of the Related Art

Recently, due to fires and explosions which occur during the use of lithium secondary batteries, social concerns about the safety of battery use have been increasing. Based on these social concerns, one of the major development tasks of lithium secondary batteries recently is to eliminate instability such as fires and explosions caused by thermal runaway of battery cells.

In particular, a battery module/pack contains an empty space other than the battery cells, which are the energy source. If a fire occurs due to an external impact or a problem with a battery cell, the flame may spread to adjacent cells through the empty space, increasing the damage caused by the fire. Because this risk of fire could be the biggest obstacle to the electric vehicle market, research is ongoing into ways to reduce the spread of fire.

### SUMMARY

First, according to one aspect of the present disclosure, an object is to prevent or delay high-temperature gas generated in a battery cell in which thermal runaway has occurred among one or more battery cells provided inside the battery assembly from escaping in the tap direction of the battery cell.

Second, according to another aspect of the present disclosure, an object is to vent high-temperature gas generated in a battery cell that has experienced thermal runaway along an intended path.

Third, according to yet another aspect of the present disclosure, an object is to increase the stability and service life of a battery pack by increasing heat resistance or fire resistance.

Fourth, according to yet another aspect of the present disclosure, an object is to add a process of inserting an insertion member (or an insertion member, a filler portion) into an empty space formed between the bus bar assembly and the cell tab of the battery to the assembly process of the existing battery assembly.

Fifth, according to yet another aspect of the present disclosure, an object is to provide an assembly method that facilitates arrangement of an insertion member when assembling a battery assembly.

A battery assembly according to the present disclosure may be widely applied in the field of green technology such as electric vehicles, battery charging stations, energy storage systems (ESS), and other battery-based photovoltaics and wind power. In addition, the battery assembly according to the present disclosure may be used for eco-friendly mobility, including electric vehicles and hybrid vehicles, to prevent climate change by suppressing air pollution and greenhouse gas emissions.

In order to solve the above-described tasks, a battery assembly according to the present disclosure may include a plurality of battery cells staked and arranged in a predetermined stacking direction, an accommodation case accommodating the plurality of battery cells, an insertion space formed between the plurality of battery cells and the accommodation case in the stacking direction, and an insertion member located in the insertion space, wherein the insertion member may include a support body forming the buffer space, and a rib portion dividing the buffer space into a plurality of divided spaces.

According to an embodiment, each of the plurality of battery cells may include a main body including an electrode assembly producing or storing electrical energy, and a lead tab portion connected to the electrode assembly and protruding outside from the main body, and wherein the insertion space may be formed between lead tab portions of the plurality of battery cells.

In addition, the battery assembly according to the present disclosure may further include a bus bar electrically connected to the plurality of battery cells, wherein the insertion space may be formed by the main body of each of the plurality of battery cells, the lead tab portion of each of the plurality of battery cells, and the bus bar.

According an embodiment, the support body may include a body inner surface forming an inner surface of the buffer space, and wherein the rib portion may include a first rib protruding from a portion of the body inner surface, extending across the buffer space, and connected to another side of the body inner surface.

According to an embodiment, the rib portion may further include a second rib extending in a direction inclined or perpendicular to the first rib and connected to the first rib or the body inner surface.

According to an embodiment, the first rib and the second rib may include a plurality of first ribs and a plurality of second ribs respectively, and wherein the plurality of second ribs may connect between the plurality of first ribs or between the plurality of first ribs and the body inner surface.

According to an embodiment, each of both ends of the first rib may be branched and connected to the body inner surface.

According to an embodiment, the rib portion may include a first intersection rib and a second intersection rib intersecting each other and connected to the first rib or the body inner surface.

According to an embodiment, the first rib, the first intersection rib, and the second intersection rib may include a plurality of first ribs, a plurality of first intersection ribs, and a plurality of second intersection ribs respectively, and wherein the plurality of first intersection ribs and the plurality of second intersection ribs may be located between the plurality of first ribs or between the plurality of first ribs and the body inner surface.

According to an embodiment, an intersection of the first intersection rib and the second intersection rib may be located between the plurality of first ribs or between the plurality of first ribs and the body inner surface.

According to an embodiment, the first rib may be disposed in the stacking direction.

According to an embodiment, the insertion member may include a fire-resistant material.

According to an embodiment, the support body may have a pipe shape in which both ends are open in the height direction of the accommodation case.

According to an embodiment, a virtual cross section of the support body may be a rectangular shape at a predetermined height of the accommodation case.

According to an embodiment, the rib portion may extend lower than a lower end of the support body in a height direction of the accommodation case.

According to an embodiment, the support body and the rib portion may be integrally formed.

According to an embodiment, the support body may include a first body layer forming an inner surface of the buffer space and connected to at least a portion of the rib portion, and a second body layer surrounding the first body layer and forming an outer surface of the support body.

According to an embodiment, the first body layer and the second body layer may include materials different from each other.

According to an embodiment, a virtual cross section of divided spaces partitioned by the rib portion may be a hexagonal shape at a predetermined height of the accommodation case.

A method of assembling a battery assembly according to the present disclosure may include stacking the plurality of battery cells, coupling the plurality of stacked battery cells to the accommodation cover, inserting an insertion member including a buffer space into an insertion space formed between lead tap portions of the plurality of battery cells, and coupling the accommodation body to the accommodation cover.

First, according to an embodiment of the present disclosure, a high-temperature gas generated in a battery cell in which thermal runaway occurs among one or more battery cells located in the battery assembly may be prevented or delayed from escaping in a tap direction of the battery cell.

Second, according to another embodiment of the present disclosure, the high-temperature gas generated in the battery cell where the thermal runaway has occurred may be vented according to the intended path.

Third, according to yet another aspect of the present disclosure, a process of inserting an insertion member (or an insertion subsidiary material, a filler portion) into an empty space formed between the bus bar assembly and the cell tab of the battery may be added to the existing assembly process of the battery assembly.

Fourth, according to yet another aspect of the present disclosure, the arrangement of the insertion member may be facilitated when assembling the battery assembly.

Fifth, according to yet another aspect of the present disclosure, the stability of the battery assembly may be improved by increasing the heat resistance or fire resistance of the battery assembly.

### BRIEF DESCRIPTION OF THE DRAWINGS

FIG. 1 is an example of a battery assembly according to the present disclosure.

FIG. 2 is an example of disassembling a battery assembly according to the present disclosure.

FIG. 3 illustrates a battery assembly according to the present disclosure viewed from above.

FIG. 4 is an example of an insertion member accommodated in an insertion space according to the present disclosure viewed from above.

FIGS. 5A and 5B each illustrates an example of an insertion member according to the present disclosure.

FIG. 6A and 6B each illustrates another example of an insertion member according to the present disclosure.

FIG. 7A and 7B each illustrates yet another example of an insertion member according to the present disclosure.

FIG. 8 is a comparison of an example of the shape of the insertion member before and after the swelling of a battery cell.

FIG. 9 is a comparison of another example of the shape of the insertion member before and after the swelling of the battery cell.

FIG. 10 is a flowchart illustrating an example of a method of assembling a battery assembly according to the present disclosure.

FIG. 11 is another example of a battery assembly according to the present disclosure.

### DETAILED DESCRIPTION

Hereinafter, referring to the accompanying drawings, preferred embodiments of the present disclosure will be described in detail. The configuration of a device or a control method described below is intended to illustrate embodiments of the present disclosure and is not intended to limit the scope of the present disclosure, and reference numbers used identically throughout the specification represent identical components.

In addition, battery assemblies 200 and 300 according to the present disclosure collectively refer to a battery module, a battery pack, or an energy storage system. In addition, the battery assemblies 200 and 300 according to the present disclosure may refer not only to battery modules but also refer to battery packs that accommodate battery cells without battery modules, such as cell to pack (CTP).

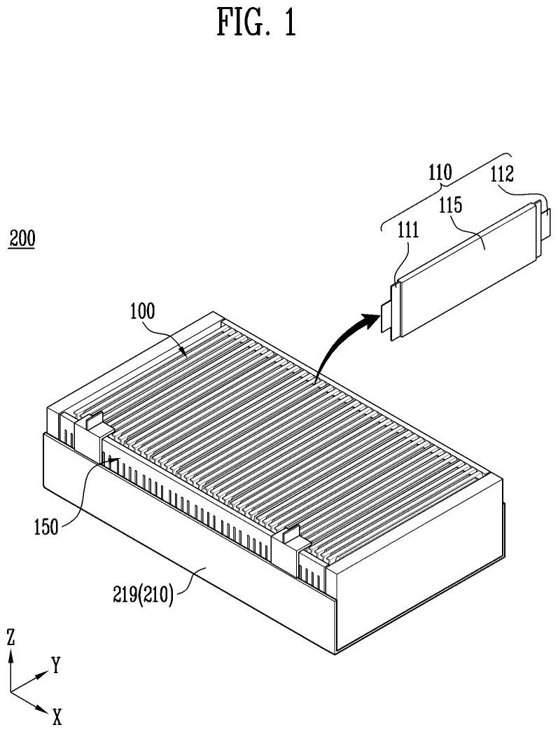

FIG. 1 is an example of a battery assembly 200 according to the present disclosure.

Referring to FIG. 1, the battery assembly 200 includes a plurality of battery cells 110 and an accommodation case 210 that accommodates the plurality of battery cells 110.

Each of the plurality of battery cells 110 may include a main body 115 that generates or stores electrical energy, and lead tab portions 111 and 112 that protrude from the main body 115 to the outside of the main body 115. The main body 115 may include an electrode assembly (not shown) including an anode and a cathode therein for the production and storage of electrical energy therein.

In addition, the main body 115 further includes an electrolyte (not shown) in contact with the electrode assembly. The electrolyte may be liquid or solid. In addition, when the electrolyte is a liquid, the electrode assembly may further include a separation membrane for separating the positive electrode and the negative electrode. Referring to FIG. 1, the main body 115 may have the form of a pouch sealed with a film-shaped exterior material.

FIG. 1 illustrates an example of the battery cell 110 having the form of a pouch, but the present disclosure is not limited thereto. Therefore, the embodiments may also be applicable to rectangular and cylindrical battery cells.

The lead tab portions 111 and 112 may include a first lead tab portion 111 and a second lead tab portion 112 that protrude from both sides of the main body 115 in a direction away from the main body 115. The configuration of the lead tab portions 111 and 112 is not limited thereto and the lead tab portions 111 and 112 may be provided with both tabs on one side.

The accommodation case 210 may protect the plurality of battery cells 110 from an external impact such as vibration. The accommodation case 210 may include an accommodation body 219 forming a portion of an accommodation space 280 that accommodates the plurality of battery cells 110 to be described later.

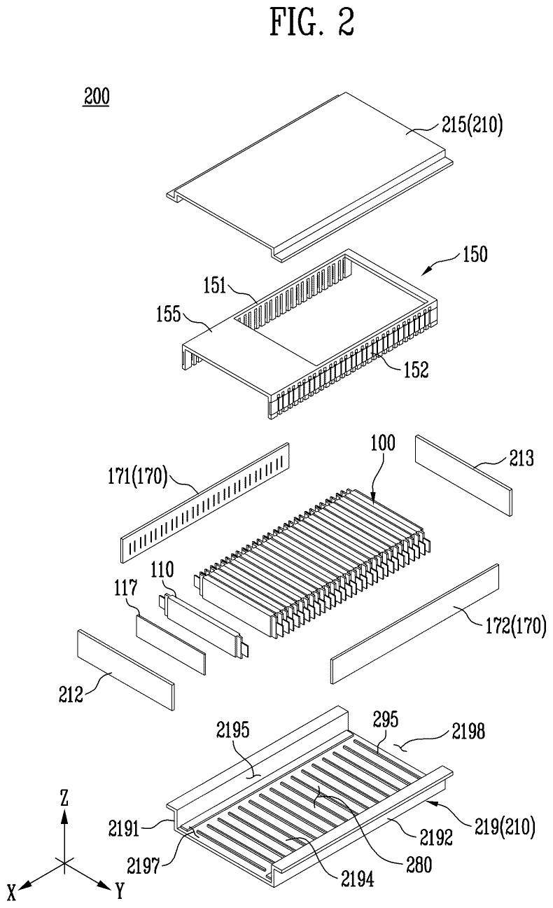

In addition, the battery assembly 200 may further include a bus bar assembly 150 that electrically connects the plurality of battery cells 110 to the outside. The bus bar assembly 150 may include a bus bar 170 (refer to FIG. 2) that electrically connects the plurality of battery cells 110 to output a predetermined voltage. A form in which the bus bar assembly 150 or the bus bar 170 to be described later is assembled with the plurality of battery cells 110 may be referred to as a cell stacking assembly 100.

FIG. 2 is an example of disassembling a battery assembly according to the present disclosure. Referring to FIG. 2, the accommodation case 210 may include an accommodation body 219 forming the portion of the accommodation space 280 that accommodates the plurality of battery cells 110, and an accommodation cover 215 connected to the accommodation body 219 to form the accommodation space 280 together.

The plurality of battery cells 110 may be located to overlap each other in a predetermined stacking direction (e.g., in a X direction) in the accommodation body 219.

The accommodation case 210 may include an open upper face 2195, the accommodation body 219 that accommodates the plurality of battery cells 110 through the open upper face 2195, and may further include an accommodation cover 215 that is connected to the accommodation body 219 and covers the open upper face 2195.

Accordingly, the accommodation cover 215 may be connected to the accommodation body 219 to form an upper face of the accommodation space 280 or an upper face of the accommodation case 210. That is, the accommodation cover 211 may be connected to the accommodation body 219 to cover the open upper face 2195, and may form the accommodation space 280 together with the accommodation body 299.

The accommodation space 280 may be formed in the accommodation body 219 and may have a space for accommodating the cell stacking assembly 100. In addition, the accommodation space 280 may further include an insertion space 288 to be described later.

The accommodation body 219 may have a channel shape or a U-shape with an upper portion is opened. Referring to FIG. 2, among side faces of the accommodation body 219, both side faces 2197 and 2198 of the accommodation body 219 facing each other in the X direction may also be opened.

That is, the accommodation body 219 may include a body bottom face 2194 forming a bottom face of the accommodation space 280, and body side faces 2191 and 2192 extending toward the accommodation cover 211 from an edge (not shown) provided parallel to the stacking direction among edges of the body bottom face 2194. A free end of the body side faces 2191 and 2192 may be bent to form a flange (not shown) for easier coupling with the accommodating cover 211.

Referring to FIGS. 1 and 2, the height of the accommodation body 219 may be smaller than the heights of the plurality of battery cells 110. However, it is mere an example and the height of the accommodation body 219 may be greater than or equal to the height of the plurality of battery cells 110.

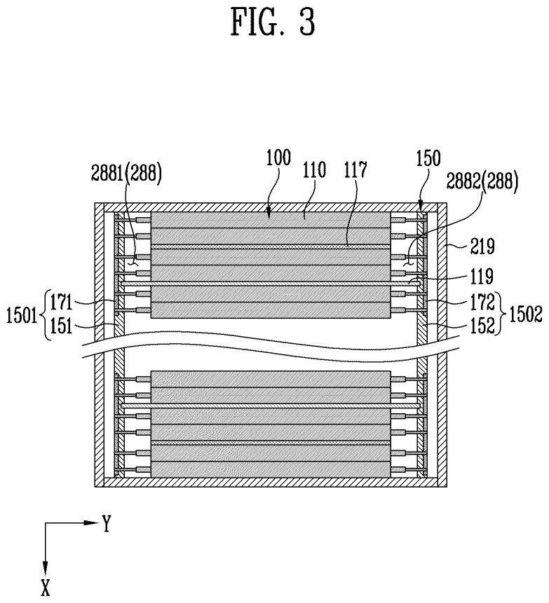

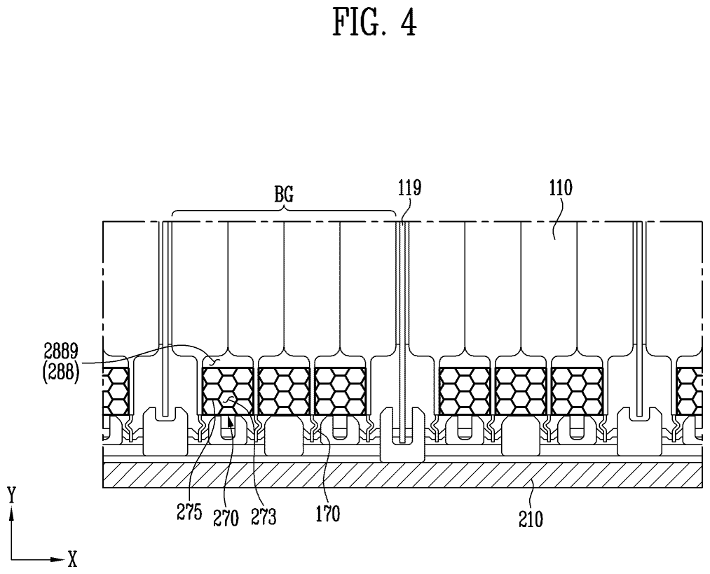

The cell stacking assembly 100 may further include a buffer member 117 or a thermal barrier member 119 (refer to FIG. 3) located between the plurality of battery cells 110. The buffer member 117 may be located between the battery cells 110 or may be located between battery groups BG (refer to FIG. 4) in which the plurality of battery cells 110 are grouped. The same may be applied to the thermal barrier member 119.

The thermal barrier member 119 may serve as a thermal barrier to prevent flames or heat from spreading to other adjacent battery cells 110 when one battery cell 110 is thermally runaway.

The cell stacking assembly 100 may include at least one buffer member 117. Likewise, the cell stacking assembly 100 may include at least one or more of the thermal barrier members 119. Alternately, the buffer member 117 and the thermal barrier member 119 may be formed as a single member to simultaneously perform a heat blocking function and a shock absorbing function.

The thermal barrier member 119 may have a multi-layer structure in a stacking direction of the plurality of battery cells 110. In other words, one layer of the multi-layer structure may include a flame retardant material (or a fire-resistant material). In addition, another layer of the multi-layer structure may reduce the pressure applied to other battery cells 110 when the battery cells 110 are swollen.

The plurality of battery cells 110 and the plurality of buffer members 117 may be provided at a predetermined location and may be stacked. For example, referring to FIG. 2, an example in which long edges of the plurality of battery cells 110 are provided in parallel to the Y direction is shown. Therefore, the plurality of battery cells 110 and the plurality of buffer members 117 may be located to overlap each other in the X direction. The same may be applied to the thermal barrier member 119.

The thermal barrier member 119 may include a fire-resistant (heat-resistant or flammable) material. For example, the thermal barrier member 119 may be include a material such as a refractory polymer, aerogel, or mica.

Referring to FIG. 2, the battery assembly 200 may further include end plates 212 and 213 at both ends of the cell stacking assembly 100 in the stacking direction. The end plates 212 and 213 may be provided on the both ends of the cell stacking assembly 100 or may connected to the both side faces 2197 and 2198 of the accommodation body 219.

The end plates 212 and 213 may prevent the both ends of the cell stacking assembly 100 from being exposed to the outside.

The battery assembly 200 may include the bus bar 170 electrically connected to the plurality of battery cells 110. In addition, the battery assembly 200 may further include bus bar frames 151, 152, and 155 supporting the bus bar 170 and the plurality of battery cells 110. The bus bar 170 and the bus bar frames 151, 152, and 155 may be collectively referred to as the bus bar assembly 150. That is, the bus bar assembly 150 may include the bus bar 170 electrically connected to the plurality of battery cells 110.

The bus bar frames 151, 152, and 155 may be electrically connected to the outside to store (or charge) electrical energy in the plurality of battery cells 110 or to supply (or discharge) electrical energy stored in the plurality of battery cells 110 to the outside.

The bus bar assembly 150 may include a first bus bar frame 151 and a second bus bar frame 152 extending in the stacking direction of the plurality of battery cells 110 with the plurality of battery cell 110 interposed therebetween.

In addition, the bus bar assembly 150 may further include a support frame 155 that is located on one side of the bus bar assembly 150 and connects the first bus bar frame 151 and the second bus bar frame 152.

The bus bar assembly 150 is described using a case where the lead tab portions 111 and 112 are respectively located in opposite directions of the main body 115. Unlike those shown, when the lead tab portions 111 and 112 are located on one side of the main body 115 and are located in the same direction, the bus bar frames 151 and 152 may be located on one side, e.g., on an upper portion of the main body 115, and electrically connected to the lead tab portions 111 and 112.

The support frame 155 may prevent modification of the first bus bar frame 151 and the second bus bar frame 152 and may support the first bus bar frame 151 and the second bus bar frame 152. In addition, a portion of an electrical device for sensing and controlling the plurality of battery cells 110 may be disposed over the support frame 155.

Referring to FIG. 2, the bus bar assembly 150 may have a tunnel shape. The length of the first bus bar frame 151 and the length of the second bus bar frame 152 in the stacking direction may be greater than the length of the support frame 155.

That is, the support frame 155 may be connected to the first bus bar frame 151 and the second bus bar frame 152 to cover upper portions of the plurality of battery cells 110. That is, the support frame 155 may cover not only some of the upper portions of the plurality of battery cells 110 but also all of them.

Referring to FIG. 2, the bus bar 170 may include a first bus bar 171 supported by the first bus bar frame 151 and electrically connected to the first lead tab portion 111, and a second bus bar 172 supported by the second bus bar frame 152 and electrically connected to the second lead tab portion 112.

The first bus bar 171 and the second bus bar 172 may be located farther away from the plurality of battery cells 110 than the first bus bar frame 151 and the second bus bar frame 152, respectively. That is, the first bus bar 171 and the second bus bar 172 may be located closer to the body side faces 2191 and 2192 than the first bus bar frame 151 and the second bus bar frame 152. Therefore, the first lead tab portion 111 and the second lead tab portion 112 may be inserted into slit holes (not shown) formed in the first bus bar frame 151 and the second bus bar frame 152, respectively, to be electrically connected to the first bus bar 171 and the second bus bar 172. However, this is mere an example and the first lead tab portion 111 and the second lead tab portion 112 may be electrically connected to the first bus bar 171 and the second bus bar 172 in a different manner, respectively.

The battery assembly 200 may further include a heat dissipator 295 located between the body bottom face 2194 and the plurality of battery cells 110 to transfer heat generated in the plurality of battery cell 110 to the outside of the battery assembly 200. The heat dissipator 295 may include an adhesive material having thermal conductivity, for example, a heat dissipating adhesive. Therefore, the plurality of battery cells 110 may be bonded to the body bottom face 2194 through the heat dissipator 295. To this end, the heat dissipator 295 may be formed on the body bottom face 2194.

FIG. 3 illustrates the battery assembly 200 according to the present disclosure viewed from above.

The bus bar assembly 150 may include the first bus bar 171 electrically connected to the first lead tab portion 111 and the first bus bar frame 151 supporting the first bus bar 171. The first bus bar 171 and the first bus bar frame 151 may be collectively referred to as a first bus bar assembly 1501. That is, the first bus bar assembly 1501 is electrically connected to the first lead tab portion 111 and may support the cell stacking assembly 100.

The bus bar assembly 1502 may further include the second bus bar 172 electrically connected to the second lead tab portion 112 and the second bus bar frame 152 supporting the second bus bar 172. The second bus bar 172 and the second bus bar frame 152 may be collectively referred to as a second bus bar assembly 1502. That is, the second bus bar assembly 1502 is electrically connected to the second lead tab portion 112 and may support the cell stacking assembly 100 together with the first bus bar assembly 1501.

Referring to FIG. 3, an empty space (hereinafter, referred to as an insertion space 288) may be formed between the plurality of battery cells 110 and the bus bar assembly 150 due to the electrical connection between the lead tab portions 111 and 112 and the bus bar assembly 150.

In other words, the portion of the accommodation space 280 formed in the accommodation case 210 may be a space for accommodating the plurality of battery cells 110 and the other side of the accommodation space 280 may be a space for the insertion space 288.

Specifically, the insertion space 288 is a space formed by each of the main body 115, the lead tab portions 111 and 112, and the bus bar 170. In normal cases, thermal runaway occurs in any one of the plurality of battery cells 110, and high-temperature heat may be propagated to other adjacent battery cells through the insertion space 288 when off-gas occurs. The insertion space 288 may be filled in order to prevent such thermal propagation.

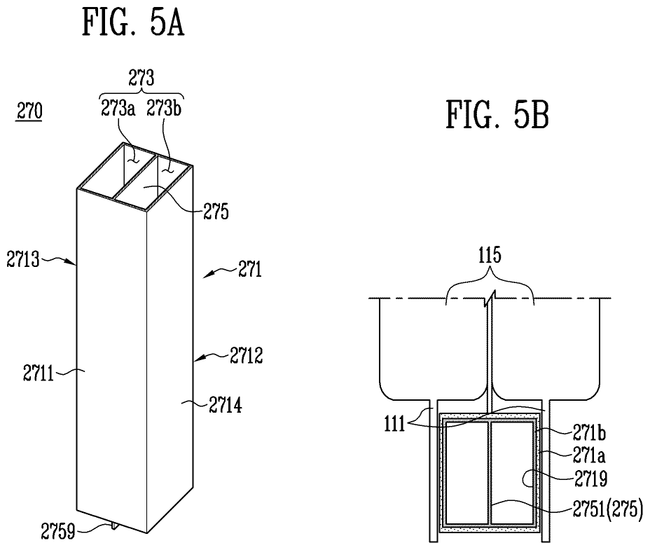

To this end, the battery assembly 200 according to the present disclosure may include an insertion member 270 (refer to FIG. 5A) inserted into the insertion space 288.

That is, the battery assembly 200 according to the present disclosure may include the plurality of battery cells 110 stacked and arranged in the predetermined stacking direction, the accommodation case 210 accommodating the plurality of battery cells 110, the insertion space 288 formed between the plurality of battery cells 110 and the accommodation case 210 in the stacking direction, and the insertion member 270 located in the insertion space 288.

Referring to FIG. 3, the buffer member 117 may be positioned between the plurality of battery cells 110. The buffer member 117 may be provided between each of the plurality of battery cells 110. Alternatively, the buffer member 117 may be located between the battery groups BG (refer to FIG. 4) in which adjacent battery cells 110 are grouped into a predetermined number of groups.

Referring to FIG. 3, the length of the buffer member 117 in a direction from the first bus bar frame 151 toward the second bus bar frame 152 is illustrated as being less than or equal to the length of the main body 115 (refer to FIG. 1), but is not limited thereto.

Referring to FIG. 3, the thermal barrier member 119 may be located between the plurality of battery cells 110. The thermal barrier member 119 may be provided between each of the plurality of battery cells 110. Alternatively, the thermal barrier member 119 may be located between the battery groups BG in which the adjacent battery cells 110 are grouped into the predetermined number of groups.

The battery group BG refers to a set of battery cells in which the adjacent battery cells 110 among the plurality of battery cells 110 are grouped into the predetermined number of groups. The plurality of battery cells 110 may be grouped into the predetermined number of groups for a predetermined target voltage or target current, and then the battery groups BG may be connected in series or in parallel using the bus bar 170.

Referring to FIG. 3, the length of the buffer member 117 in the direction from the first bus bar frame 151 toward the second bus bar frame 152 is illustrated as being less than or equal to the length of the main body 115 (refer to FIG. 1), but is not limited thereto.

On the other hand, referring to FIG. 3, the thermal barrier member 119 and the buffer member 117 are illustrated as being separated from each other. However, as described above, the thermal barrier member 119 and the buffer member 117 may be formed as one member and may be referred to as an insertion member (not shown).

That is, the insertion member may be located between the plurality of battery cells 110 to buffer the surface pressure of the battery cell during thermal runaway and swelling.

The length of the thermal barrier member 119 in the direction from the first bus bar frame 151 toward the second bus bar frame 152 may be greater than a length of the main body 115. More specifically, the thermal barrier member 119 may be in contact with the first bus bar assembly 1501 and the second bus bar assembly 1502. The thermal barrier member 119 may block or delay the propagation of heat or flame to other places when any battery cell 110 is thermally runaway.

FIG. 4 is an example of the insertion member 270 accommodated in the insertion space 288 according to the present disclosure viewed from above.

Referring to FIG. 4, the battery assembly 200 according to the present disclosure includes the plurality of battery cells 110 stacked and arranged in the predetermined stacking direction, the accommodation case 210 accommodating the plurality of battery cells 110, the insertion space 288 formed between the plurality of battery cells 110 and the accommodation case 210 in the stacking direction, and the insertion member 270 located in the insertion space 288.

As described above, the insertion space 288 may be formed between the plurality of battery cells 110 and the bus bar assembly 150 (or the bus bar 170). The insertion space 288 may be formed by connecting each of the lead tab portions 111 and 112 to the bus bar assembly 150 (or the bus bar 170).

The insertion space 288 may include a plurality of separation spaces 2889 separated by the lead tab portions 111 and 112. Each of the lead tab portions 111 and 112 does not separate the plurality of separation spaces 2889 so as to be isolated. That is, since the length of each of the lead tab portions 111 and 112 is smaller than the height of the accommodation space 280 in the height direction of the accommodation case 210, only at least a portion of the plurality of separation spaces 2889 is separated in the height of the accommodating space 280.

That is, since the length of each of the lead tab portions 111 and 112 in the height direction of the accommodation case 210 is smaller than the length of each main body 115, the plurality of insertion spaces 288 may be separated by each of the lead tap portions 111 and 112 or may communicate with each other.

More specifically, the plurality of first insertion spaces 2881 may be formed by the first lead tab part 111, and the plurality of first insert spaces 2881 may communicate with each other. Similarly, the plurality of second insertion spaces 2882 may be formed by the second lead tab portion 112, and the plurality of second insert spaces 2882 may communicate with each other.

Therefore, as described above, the plurality of separation spaces 2889 may communicate with each other. In addition, a plurality of insertion members 270 may be provided and inserted into the plurality of separation spaces 2889, respectively.

Meanwhile, referring to FIG. 4, the battery assembly 200 may further include the thermal barrier member 119 positioned between the plurality of battery cells 110. Alternatively, the battery assembly 200 may further include a thermal barrier member 119 positioned between the battery groups BG in which the plurality of battery cells 110 are grouped.

Referring to FIG. 4, the thermal barrier member 119 may be provided side by side with the plurality of battery cells 110 to extend to the bus bar assembly 150. More specifically, the thermal barrier member 119 may extend to and be inserted into the bus bar frames 151, 152. The insertion member 270 may not be inserted into the space into which the thermal barrier member 119 is inserted to prevent interference between the insertion member 270 and the thermal barrier member 119.

Meanwhile, the first insertion space 2881 may be separated by the first lead tab portion 111. In addition, the second insertion space 2882 may be separated by the second lead tab portion 112. However, when the cell stacking assembly 100 is accommodated in the accommodation body 219, since the lengths of the first lead tab portion 111 and the second lead tab portion 112 in the height direction of the accommodation case 210 or the accommodation body 219 are smaller than the height of the battery cell 110, the first insertion space 2881 and the second insertion space 2882 may communicate with each other.

In addition, the first insertion space 2881 and the second insertion space 2882 may communicate with each other through a space between the plurality of battery cells 110 and the accommodation cover 215. Therefore, the first insertion space 2881 and the second insertion space 2882 may communicate with each other, not be separated and isolated from each other.

The insertion member 270 may be located in at least one of the first insertion space 2881 and the second insertion space 2882.

The insertion member 270 includes a support body 271 that forms a buffer space 273 therein and extends in the height direction of the accommodation case 210 (refer to FIG. 5A), and a rib portion 275 that extends in the height direction of the accommodation case 210 and divides the buffer space 273 into a plurality of divided spaces 273a and 273b (refer to FIGS. 5A to 7).

Referring to FIG. 4, the rib portion 275 illustrates a portion of the buffer space 273 in a hexagonal shape (e.g., a honeycomb structure). More specifically, a virtual cross-section of the divided spaces 273a and 273b partitioned by the rib portion 275 at a predetermined height of the accommodation case 210 may have a hexagonal shape. This is only an example and may be modified in various ways.

The insertion member 270 may be located in the insertion space 288 to delay the propagation of flames or heat to other adjacent battery cells 110 through the insertion space 228 during thermal runaway of one of the battery cells 110. When the insertion space 288 is an empty space, the insertion space 288 may be a passage for flame or high-temperature gas propagation. Therefore, the insertion member 270 may be inserted into the insertion space 288 to effectively minimize or prevent propagation of flame or high-temperature gas.

In addition, the insertion member 270 may be include a fire-resistant material in order to minimize the propagation of flame or high-temperature gas.

Therefore, the melting point of the insertion member 270 may be greater than the ignition points of the plurality of battery cells 110. The ignition points of the plurality of battery cells 110 may be a temperature at which venting occurs in the battery cell 110. Alternatively, when the exterior material (or the accommodating case) of the battery cell 110 is torn or opened in a thermal runaway situation, the ignition points may be a temperature of the electrolyte accommodated in the battery cell 110, that is, inside the main body 115.

When one of the battery cells 110 starts thermal runaway, the exterior material may be torn or opened to release high-temperature gas or flame from the inside of the battery cell 110. Even so, the insertion member 270 may maintain an original shape to prevent the insertion member 270 from burning or melting. In addition, the shape of the insertion space 288 may be modified due to the expansion (or swelling) of one of the battery cells 110. According to the modification of the shape of the insertion space 288, the shape of the insertion member 270 may also modified to maintain the effect of filling the insertion space 288. To this end, the insertion member 270 may be include a flexible material.

As described above, even if the thermal runaway of the battery cell 110 occurs in the insertion member 270, the insertion member 270 may not burn or melt and the outer shape of the insertion member 270 may be maintained without significant change.

The insertion member 270 may include a porous material. The porous material may include pores inside. The shape of the pores may be irregular and unstructured. Preferably, the porosity of the insertion member 270 may be 20% or more and 30 percent % or less.

The refractory material may also be an inorganic compound. That is, the insertion member 270 may include a refractory material formed of an inorganic compound. The inorganic compound may be any one compound selected from the group consisting of Alum (K₂SO₄·Al₂(SO₄)3·24H₂O), Borax (Na₂B₄O₇·10H₂O), Lime Water (aqueous solution of Ca(OH)₂), Quicklime (CaO), white emulsion made by mixing Milk of Lime Ca(OH)₂ with water, Slaked Lime (Ca(OH)₂), Washing Soda (Na₂CO₃·10H₂O), Apatite (Ca₅(PO₄)₃OH), Baking Powder (a salt mixture of NaHCO₃ and tartaric acid), Baking Soda (NAHCO₃), Sodium Thiosulfate Pentahydrate (Na₂S₂O₃·5H₂O), Silica (or SiO₂), Alumina (or Al₂O₃), Calcium Oxide (CaO), Calcium Sulfate (CaSO₄), Calcium Chloride (CaCl₂), Sodium Carbonate (Na₂O₃), Potassium Chloride (KCI), Magnesium Oxide (MgO), ZrO₂, Crom Oxide (Cr₂O₃), Aluminum Hydroxide (Al(OH)₃), Antimony Trioxide (Sb₂O₃), Antimonyl Oxide (Sb₂O₅), Oxide, Magnesium Hydroxide (Mg(OH)₂) and a zinc borate compound, a phosphorus-based compound, a nitrogen-based guanidine compound or a molybdenum compound, or a mixture thereof.

In an embodiment, the insertion member 270 may include silica (silicon dioxide). Considering the melting point of silica (1713° C.), the insertion member 270 may minimize the propagation of heat or off-gas generated during the thermal runaway to other places. In addition, the shape of the insertion member 270 may remain unchanged during the thermal runaway of the battery cell 100.

In another embodiment, the insertion member 270 may include silica gel. The silica gel may include a porous material having a powder shape made by treating an aqueous solution of sodium silicate (Na₂SiO₃) with an acid. Specifically, the silica gel may be obtained by mixing sodium silicate and an aqueous inorganic acid solution (such as sulfuric acid) to form a silica hydrosol and curing the hydrosol with a hydrogel. In consideration of the above-described conventional method of the silica gel, the main component (component that accounts for 50% or more) of the silica gel is silicon dioxide, and other components may further include aluminum oxide, iron (III) oxide (Fe₂O₃, Iron (III) Oxide, or Ferric Oxide), or sodium. Therefore, the melting point of the silica gel may be approximately 1600° C. or more.

Preferably, the silica gel may include silicon dioxide 90% or more. In addition, since the silica gel includes a porous material, the porosity of the insertion member 270 may be equal to 20% or more and 30% or less.

In addition, the insertion member 270 may include an aerogel since aerogels not only have low thermal conductivity, but also have the property of retaining moisture and expanding in a high-humidity environment.

Considering that the insertion member 270 includes a refractory material such as silica gel, alumina gel, or aerogel, the insertion member 270 may include silicon dioxide (SiO₂).

In addition to silica gel, the insertion member 270 may include any other material as long as the material has porosity and flame retardancy (heat resistance or fire resistance). In addition, the insertion member 270 not only includes a single material, but may include various fire-resistant materials.

In another embodiment, the insertion member 270 may refer to a polymer material having a V-0 grade in the 94V Test (Vertical Burning Test) of the UL (Underwriter's Laboratory), which is a flame retardant standard for polymer materials.

Specifically, the insertion member 270 may include a flame-retardant polymer. The above flame retardant materials include phosphorus-based, halogen-based, and inorganic flame retardants, and preferably, in the case of phosphorus-based flame retardant materials, a phosphate compound, a phosphonate compound, a phosphinate compound, a phorsphine oxide compound, and a phosphazene compound, and metal salts thereof may be included. They may be used singly or in combination of two or more kinds.

In another specific embodiment, the phosphorus-based flame retardant may be, but is not limited to, diphenyl phosphate, diaryl phosphate, triphenyl phosphate, tricresyl phosphate, trixyrenyl phosphate, tri (2,6-dimethylphenyl)phosphate, tri (2,4,6-trimethylphenyl)phosphates, tri (2,4-ditertiarybutylphenyl)phosphate, tripe (2,6-Dimethylphenyl) phosphate, bisphenol-A-bis (diphenylphosphate), resorcinol bis (diphenyl phosphate), resorchinol bis [bis (2,6-dimethylphenyl)phosphate], resorcinole bis [bith (2,4-diTERtiarybutylphenyl)phosphate], hydroquinone bis [bithe (2,6-Dimethylphenyl)phosphate]. They may be applied alone or in the form of a mixture of two or more.

FIGS. 5A and 5B each illustrates an example of the insertion member 270.

As described above, the insertion space 288 may be formed between the lead tab portions of the plurality of battery cells 110. In other words, the insertion space 288 may be located between the plurality of battery cells 110 and the bus bar 170. The insertion member 270 may be disposed in the insertion space 288.

Referring to FIG. 5A, the insertion member 270 includes the support body 271 that forms the buffer space 273 therein and extends in the height direction of the accommodation case 210, and the rib portion 275 that extends in the height direction of the accommodation case 210 and divides the buffer space 273 into the plurality of divided spaces 273a and 273b.

In addition, the support body 271 may include a body inner surface 2719 that forms an inner surface of the buffer space 273, and the rib portion 275 may include a first rib 2751 that protrudes from a portion of the body inner surface 2719 and crosses the buffer space 273 to be connected to another side of the body inner surface 2719.

That is, the support body 271 may have a pipe shape. Therefore, the inside of the support body 271 may be a hollow space and the hollow space may be referred to as the buffer space 273. When the battery cell 110 is modified, the support body 271 may also be modified. The hollow space may prevent destruction of the support body 271 and may perform a buffering role.

A cross section of the pipe shape may be rectangular or circular. Various types of pipes may be acceptable as well as the insertion space 288 is filled better.

Referring to FIG. 5B, an example of which a virtual cross section of the support body 271 having a rectangular shape in a direction perpendicular to the height direction of the accommodation case 210 is illustrated. The support body 271 may include a first surface 2711, a second surface 2712, a third surface 2713, and a fourth surface 2714 forming side faces of the buffer space 273 in the height direction of the accommodation case 210.

Meanwhile, opposite ends of the support body 271 may be opened in the height direction of the accommodation case 210. In addition, the rib portion 275 may extend lower than the lower end 2759 of the support body 271 such that the support body 271 may be supported more stably on the body bottom face 2194 when all the lower edges of the supporting body 272 come into contact with the body bottom face 2194.

The inner side face 2719 of the body may refer to an inner side face of the support body 271 forming an outer shape and facing the buffer space 273.

The rib portion 275 may protrude from one side of the body inner surface 2719 and be connected to the other side of the body inner surface 2719. Referring to FIG. 5B, the rib portion 275 may divide the buffer space 273 into the plurality of divided spaces 273a and 273b crossing the buffer space 273, respectively.

More specifically, the rib portion 275 may connect the second surface 2712 and the first surface 2711 facing the second surface 2713 to divide the buffer space 273 into the plurality of divided spaces 273a and 273b. However, this is only an example, and when the rib portion 275 divides the buffer space 273, the other surface may be connected to another surface.

Referring to FIG. 5B, the rib portion 275 may include the first rib 2751 extending in parallel with the lead tab portions 111 and 112. Alternatively, the first rib 2751 may be disposed in a direction perpendicular to the lead tab portions 111 and 112, or the first rib 2751 may be disposed in the stacking direction of the plurality of battery cells 110. When the battery cell 110 is modified, the insertion member 270 is not moved to another position or destroyed and the insertion space 288 may be filled, the rib portion 275 may be disposed in any direction.

The support body 271 and the rib portion 275 may be integrally formed. However, the support body 271 and the rib portion 275 may include different materials from each other.

Referring to FIG. 5B, the support body 271 may include a first body layer 271b forming an inner surface of the buffer space 273 and connected to at least a portion of the rib portion 275, and a second body layer 271a surrounding the first body layer 271b and forming an outer surface of the support body 272. The first body layer 271b and the second body layer 271a may include different materials such that the insertion member 270 may delay the propagation of high-temperature gas or flame through the insertion space 288.

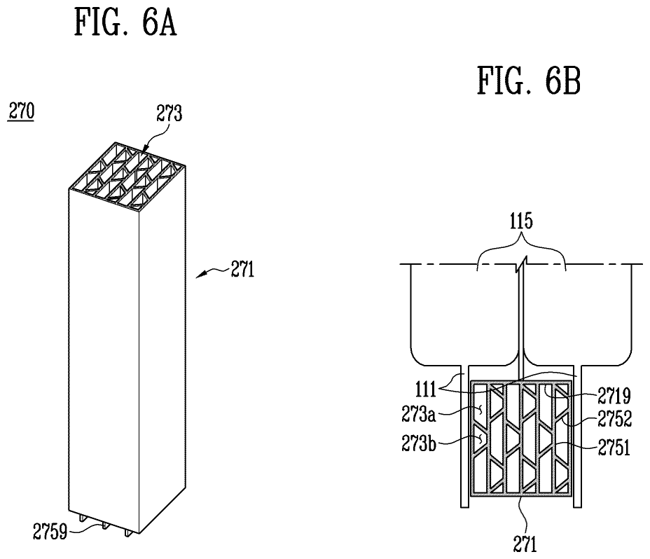

For example, the second body layer 271a may include polyurethane foam and the first body layer 271b may include aerogel. Other examples of the insertion member 270 are not shown separately for explanation and unlike the insertion member 270 illustrated in FIGS. 6 to 9, the support body 271 may be formed of a plurality of layers.

FIGS. 6A and 6B illustrate another example of the insertion member 270.

Referring to FIG. 6A, the rib portion 275 may include the first rib 2751 protruding from one side of the body inner surface 2719 and crossing the buffer space 273 and connected to the other side of the body outer surface 2719, and the second rib 2752 extending in a direction inclined or perpendicular to the first rib 2752 and connected to the first rib 2751 or the body inner surface 2719.

The cross section of the pipe shape may be rectangular or circular. Various types of pipes may be acceptable as well as the insertion space 288 is filled better.

Referring to FIG. 6B, an example of which a virtual cross section of the support body 271 having a rectangular shape in the direction perpendicular to the height direction of the accommodation case 210 is illustrated.

Opposite ends of the support body 271 may be opened in the height direction of the accommodation case 210. In addition, the rib portion 275 may extend lower than the lower end 2759 of the support body 271 such that the support body 271 may be supported more stably on the body bottom face 2194 when all the lower edges of the supporting body 272 come into contact with the body bottom face 2104.

The rib portion 275 may protrude from one side of the body inner surface 2719 and be connected to the other side of the body inner surface 2719. Referring to FIG. 6B, the rib portion 275 may divide the buffer space 273 into the plurality of divided spaces 273a and 273b crossing the buffer space 273, respectively.

That is, the rib portion 275 may include the first rib 2751 positioned in parallel with the lead tab portions 111 and 112, and the second rib 2752 vertically or inclined connected to the first rib 2752 or the body inner surface 2719, thereby dividing the buffer space 273 into divided spaces 273a and 273b having different sizes.

To this end, the first rib 2751 and the second rib 2752 may include a plurality of first ribs 2751 and a plurality of second ribs 2752, respectively, and the plurality of second ribs 2752 may connect between the plurality of first ribs 2151 or between the plurality of first ribs 2151 and the body inner surface 2719.

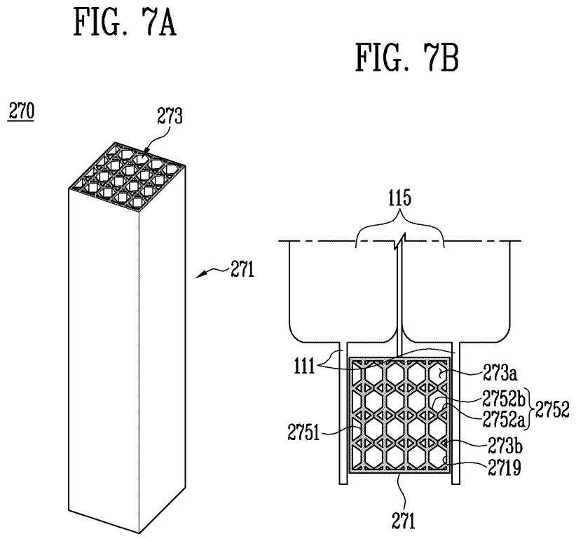

FIGS. 7A and 7B each illustrates another example of the insertion member 270.

Referring to FIG. 7A, the rib portion 275 may include the first rib 2751 protruding from one side of the body inner surface 2719 and crossing the buffer space 273 to be connected to the other side of the body inner surface 2719 and the second rib 2752 connected to the first rib 2752 or the body inner surface 2719. Specifically, the second rib 2752 may include the first intersection rib 2752a and the second intersection rib 2752b crossing and are connected to each other.

The cross section of the pipe shape may be rectangular or circular. Various types of pipes may be acceptable as well as the insertion space 288 is filled better.

Referring to FIG. 7B, an example is shown in which a virtual cross section of the support body 271 has a rectangular shape in the direction perpendicular to the height direction of the accommodation case 210.

The rib portion 275 may protrude from one side of the body inner surface 2719 and be connected to the other side of the body inner surface 2719. Referring to FIG. 7B, the rib portion 275 may divide the buffer space 273 into the plurality of divided spaces 273a and 273b crossing the buffer space 273, respectively.

That is, the rib portion 275 may include the first rib 2751 positioned in parallel with the lead tab portions 111 and 112, and the first intersection rib 2752a and the second intersection rib 2752b vertically or inclined connected to the first rib 2752 or the body inner surface 2719 and intersecting with each other, thereby partitioning the buffer space 273 into divided spaces 273a and 273b having different sizes.

To this end, the first rib 2751, the first intersection rib 2752a, the second intersection rib 2752b may include a plurality of first ribs 2751, a plurality of first intersection ribs 2752a, and a plurality of second intersection rib 2752b, respectively. The first intersection rib 2752a and the second intersection rib 2752b may connect between the plurality of first ribs 2751 or between the plurality of first ribs 2751 and the body inner surface 2719.

In addition, the intersection of the first intersection rib 2752a and the second intersection rib 2752b may be located between the plurality of first ribs 2751 or between the plurality of first ribs 2751 and the body inner surface 2719 to effectively resist modification of the insertion member 270 between the plurality of first ribs 2751 and between the plurality of first ribs 2751 and the body inner surface 2719 by the first intersection ribs 2752a and the second intersection rib 2752b.

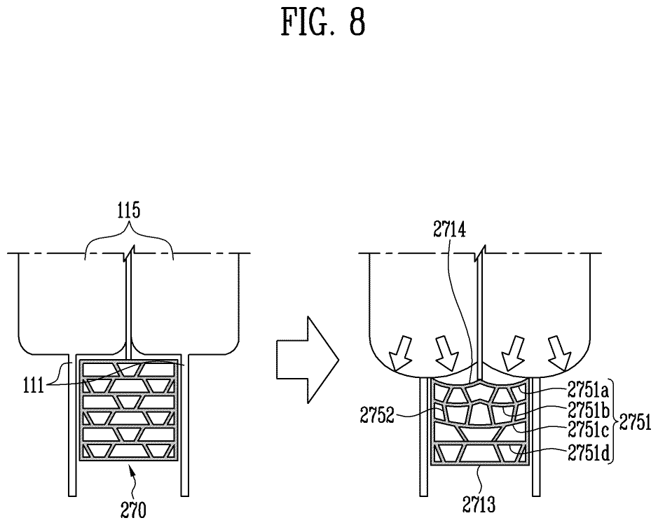

FIG. 8 is a comparison of an example of the shape of the insertion member 270 before and after the swelling of the battery cell 110.

In a situation where the plurality of battery cells 110 operate normally, the insertion member 270 may be located in the insertion space 288 to maintain a rectangular shape in a plan view. In contrast, when thermal runaway occurs in at least one battery cell 110 among the plurality of battery cells 110, the battery cell 110 in which the thermal runaway has occurred may expand (or swelling). Therefore, as the battery cell 110 expands, the shape of the insertion member 270 may also be modified. FIG. 8 illustrates a state in which the regions of the lead tab portions 111 and 112 are expanded in the battery cell 110 in which the thermal runaway occurs.

High temperature gas or flame may be released into the insertion space 288, or the shape of the insertion space 228 may be modified due to swelling of the battery cell 110. Therefore, the shape of the insertion member 270 inserted into the insertion space 288 may also be modified. To this end, the insertion member 270 may include a flexible material. In order to buffer against the modification of the battery cell 110, the rib portion 275 itself may be bent so that the insertion member 270 may be modified while supporting the insertion member 270.

Unlike those shown in FIGS. 5 to 7, FIG. 8 illustrates an example in which the first ribs 2751 are arranged in the stacking direction. As a result, the first rib 2751 and the second rib 2752 are also modified according to the modification of the battery cell 110 where the thermal runaway occurs in the directions of the lead tab portions 111 and 112. Accordingly, the first rib 2751 and the second rib 2752 may resist the external force caused by the modification of the battery cell 110. Therefore, the insertion member 270 may be fitted into the insertion space 288 in a manner similar to a tight fit method. That is, the insertion member 270 may be located in the original inserted position while only the shape is modified.

Referring to FIG. 8, the first rib 2751 may include the plurality of first ribs 2751. The plurality of first ribs 2751 may include a proximal first rib 2751a located closer to the main body 115 than the bus bar 170 and a distal first rib 2752d located closer to the bus bar 170 than the main body 115. FIG. 8 illustrates a total four of the first ribs 2751a, 2751b, 2751c, and 2751d, but the present disclosure is not limited thereto.

Referring to FIG. 8, among the body inner surfaces 2719, the body inner surface adjacent to the proximal first rib 2751a may contact the proximal first rib 2751a and may be modified into the same shape, but the body inner surface adjacent to the distal first rib 2752d and the body inner side face 2719 may hardly be modified.

That is, when the battery cell 110 is modified, the proximal first rib 2751a may be modified more than the distal first rib 2752d. The characteristics of the shape conversion may be applied to the second rib 2752.

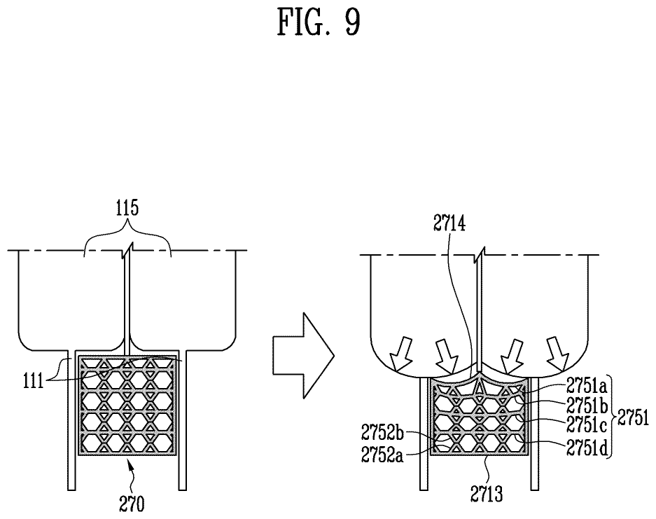

FIG. 9 is a comparison of another example of the shape of the insertion member 270 before and after the swelling of the battery cell 110.

As illustrated in FIG. 8, high-temperature gas or flame may be released into the insertion space 288, or the shape of the insertion space 228 may be modified due to swelling of the battery cell 110. Therefore, the shape of the insertion member 270 inserted into the insertion space 288 may also be modified. To this end, the insertion member 270 may include a flexible material. In order to buffer against the modification of the battery cell 110, the rib portion 275 itself may be bent so that the insertion member 270 may be modified while supporting the insertion member 270.

FIG. 9 illustrates an example in which the first ribs 2751 are arranged in the stacking direction. As a result, the first rib 2751, the first intersection rib 2752a, and the second intersection rib 2752b are also modified according to the modification of the battery cell 110 in which the thermal runaway occurs in the directions of the lead tab portions 111 and 112 and the first rib 2751, the first intersection rib 2752a, and the second intersection rib 2752b may resist the external force caused by the modification of the above battery cell 110. Therefore, the insertion member 270 may be fitted into the insertion space 288 in a manner similar to a tight fit method. That is, the insertion member 270 may be located in the original inserted position while only the shape is modified.

Referring to FIG. 9, the first rib 2751 may include the plurality of first ribs 2751. The plurality of first ribs 2751 may include the proximal first rib 2751a located closer to the main body 115 than the bus bar 170 and the distal first rib 2752d located closer to the bus bar 170 than the main body 115. FIG. 9 illustrates a total four of the first ribs 2751a, 2751b, 2751c, and 2751d, but the present disclosure is not limited thereto.

Referring to FIG. 9, among the body inner surfaces 2719, the body inner surface adjacent to the proximal first rib 2751a may contact the proximal first rib 2751a and may be modified into the same shape, but the body inner surface adjacent to the distal first rib 2752d and the body inner side face 2719 may hardly be modified.

That is, when the battery cell 110 is modified, the proximal first rib 2751a may be modified more than the distal first rib 2752d. The characteristics of the shape conversion may also be applied to the first intersection rib 2752a and the second rib 2752.

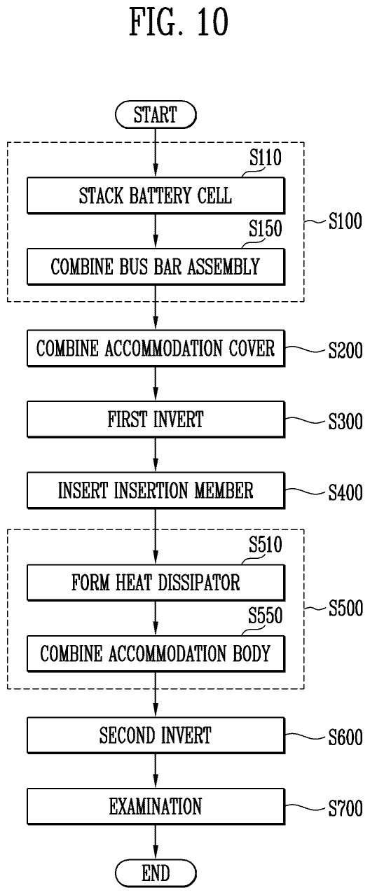

FIG. 10 is a flowchart illustrating an example of an assembly method of the battery assembly 200 according to the present disclosure.

Referring to FIG. 10, an assembly method of the battery assembly 200 according to the present disclosure may include a step S110 of stacking the plurality of battery cells 110, a step S200 of combining the plurality of stacked battery cells 110 to an accommodation cover 215, a step S400 of inserting the insertion member 270 including the rib portion 275 defining the buffer space 273 therein and dividing the buffer space 273 into the plurality of divided spaces 273a and 273b into a portion of the insertion space 288 formed between the lead tab portions 111 and 112 of the plurality of battery cell 110, and a step S500 of coupling the accommodation body 219 to the accommodation cover 215.

The method for assembling the battery assembly 200 according to the present disclosure may include, after the step S110 of stacking the plurality of battery cells 110, and the step S150 of combining the bus bar assembly 150 electrically connected to the plurality of battery cell 110.

The step S110 of stacking the plurality of battery cells 110 and the step S150 of combining the bus bar assembly 150 may be collectively referred to as a step S100 of assembling the cell stacking assembly 100.

Specifically, the step S100 of assembling the cell stacking assembly 100 may further include a stacking step (not shown) of stacking the plurality of battery cells 110 and the buffer member 117 and/or the thermal barrier member 119 located between the plurality of battery cells 110 after the step S110 of stacking the battery cells 110.

In addition, the step S100 of assembling the cell stacking assembly 100 may further include a step (not shown) of stacking the end plates 212 and 213 located at both ends of the plurality of battery cells 110 in the stacking direction in which the plurality of battery cell 110 are stacked.

After the step S100 of assembling the cell stacking assembly 100, the method for assembling the battery assembly 200 according to the present disclosure may perform a step S200 of combining the accommodation cover 215 to the plurality of stacked battery cells 110 or the cell stacking assembly 100. The accommodation cover 215 may be assembled before assembling the accommodation body 219 to protect the plurality of battery cells 110 as at least a portion of the bus bar assembly 150 is located above.

The method of assembling the battery assembly 200 according to the present disclosure may include the step S200 of combining the accommodation cover 215 to the cell stacking assembly 100. The accommodation cover 215 may be assembled before assembling the accommodation body 219 to protect the bus bar assembly 150 that is located to face the accommodation cover 215 during the process of assembling.

The method of assembling the battery assembly 200 according to the present disclosure may perform a first inverting step S300 of inverting the accommodation cover 215 and the plurality of battery cells 110 connected to the accommodation cover 225. The accommodating cover 215 may be located below the plurality of inductive battery cells 110 through the first inverting step S300.

The battery assembly 200 may be inverted to located the insertion member 270 in the insertion space 288. The battery assembly 200 being assembled may be flipped over in order to locate the insertion member 270 in the insertion space 288 as it is difficult to insert the insertion member 270 from above due to the already connected accommodation cover 215.

The method of assembling the battery assembly 200 according to the present disclosure, the step S400 of inserting the insertion member 270 into the insertion space 288 may be performed after the first inverting step S300.

Thereafter, the method of assembling the battery assembly 200 according to the present disclosure may further include a step S500 of combining the accommodation body 219 to the accommodation cover 215.

Specifically, the step S500 of combining the accommodation body 219 to the accommodation cover 215 may include a step S510 of forming the heat dissipator 295 on the body bottom face 2194 and a step S550 of combining the accommodation body 219 to the inverted accommodation cover 215 and the cell stacking assembly 100.

The heat dissipator 295 may be in contact with the cell stacking assembly 100 when the cell stacking assembly 100 is connected to the accommodation body 219.

After the accommodation body 219 and the accommodation cover 215 are combined, the method of assembling the battery assembly 200 according to the present disclosure may perform a second inverting step S600 of inverting the accommodation cover 219 and the accommodation cover 215.

That is, the accommodation cover 215 in the battery assembly 200 inverted in the first inverting step S300 may be located above the accommodation body 219 through the second inversion step S600.

Thereafter, the method of assembling the battery assembly 200 according to the present disclosure may perform an examination step S700 of the battery assembly 200.

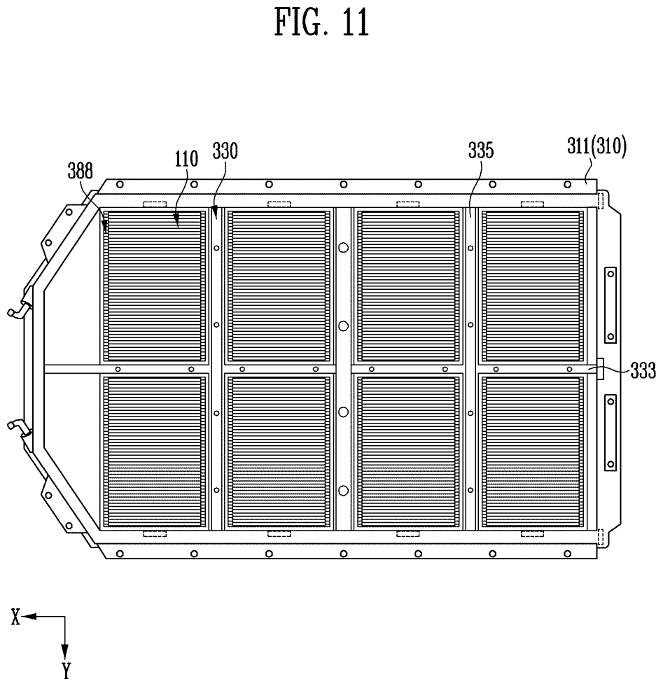

FIG. 11 is another example of a battery assembly 300 according to the present disclosure.

Although the battery assembly 200 described above is based on a battery assembly, FIG. 11 illustrates another example of the battery assembly 300 provided in the form of a battery pack. That is, the battery assembly 200 may be in the form of a CTP (Cell to Pack) structure in which the plurality of battery cells 110 are accommodated in a pack without a module while omitting the battery assembly.

The battery assembly 300 may include the plurality of battery cells 110 stacked and arranged in the predetermined stacking direction, an accommodation case 310 accommodating the plurality of battery cells, an insertion space 388 formed between the plurality of battery cell 110 and the accommodation case in the stacking direction, and the insertion member (not shown) located in the insertion space 388.

The insertion member 270 (refer to FIGS. 5 to 7) may include the support body 271 forming the buffer space 273 therein and extending in the height direction of the accommodation case 310, and the rib portion 275 that extending in the height direction of the accommodation case 310 and dividing the buffer space 273 into the plurality of divided spaces.

The accommodation case 310 may include an accommodation body 311 for accommodating the plurality of battery cells 110 and an accommodation cover (not shown) connected to the accommodation body 311. In addition, the accommodation case 310 may further include a partition 330 partitioning the insertion space 388.

The partition 330 may further include a first frame 333 and a second frame 335 partitioning the plurality of battery cells 110 horizontally and vertically. The first frame 333 and the second frame 335 may prevent modification of the accommodation body 311, but also may support and separate the plurality of battery cells 110.

Since the present disclosure may be implemented in various forms, the scope of rights is not limited to the above-described embodiments. Therefore, if the modified embodiment includes the elements of the claims of the present disclosure, it should be considered to fall within the scope of the present disclosure.

The present disclosure may be embodied in various forms and is not limited to the above-described embodiments. Therefore, if a modified embodiment includes a component of the claims of the present disclosure, it should be considered to fall within the scope of the present disclosure.

What is claimed is:

1. A battery assembly comprising:
a plurality of battery cells staked and arranged in a predetermined stacking direction;
an accommodation case accommodating the plurality of battery cells;
an insertion space formed between the plurality of battery cells and the accommodation case in the stacking direction; and
an insertion member located in the insertion space, extending in a height direction of the accommodation case, and including a buffer space therein.

2. The battery assembly according to claim 1,
wherein each of the plurality of battery cells includes:
a main body including an electrode assembly producing or storing electrical energy; and
a lead tab portion connected to the electrode assembly and protruding outside from the main body, and
wherein the insertion space is formed between lead tab portions of the plurality of battery cells.

3. The battery assembly according to claim 2, further comprising:
a bus bar electrically connected to the plurality of battery cells,
wherein the insertion space is formed by the main body of each of the plurality of battery cells, the lead tab portion of each of the plurality of battery cells, and the bus bar.

4. The battery assembly according to claim 1, wherein the insertion member includes:
a support body forming the buffer space; and
a rib portion dividing the buffer space into a plurality of divided spaces.

5. The battery assembly according to claim 4, wherein the support body includes a body inner surface forming an inner surface of the buffer space, and
wherein the rib portion includes a first rib protruding from a portion of the body inner surface, extending across the buffer space, and connected to another side of the body inner surface.

6. The battery assembly according to claim 5, wherein the rib portion further includes a second rib extending in a direction inclined or perpendicular to the first rib and connected to the first rib or the body inner surface.

7. The battery assembly according to claim 6, wherein the first rib and the second rib include a plurality of first ribs and a plurality of second ribs, and
wherein the plurality of second ribs connect between the plurality of first ribs or between the plurality of first ribs and the body inner surface.

8. The battery assembly according to claim 5, wherein each of both ends of the first rib is branched and connected to the body inner surface.

9. The battery assembly according to claim 8, wherein the rib portion includes a first intersection rib and a second intersection rib intersecting each other and connected to the first rib or the body inner surface.

10. The battery assembly according to claim 9, wherein the first rib, the first intersection rib, and the second intersection rib include a plurality of first ribs, a plurality of first intersection ribs, and a plurality of second intersection ribs, and
wherein the plurality of first intersection ribs and the plurality of second intersection ribs are located between the plurality of first ribs or between the plurality of first ribs and the body inner surface.

11. The battery assembly according to claim 10, wherein an intersection of the first intersection rib and the second intersection rib is located between the plurality of first ribs or between the plurality of first ribs and the body inner surface.

12. The battery assembly according to claim 5, wherein the first rib is disposed in the stacking direction.

13. The battery assembly according to claim 4, wherein the support body has a pipe shape in which both ends are open in the height direction of the accommodation case.

14. The battery assembly according to claim 13, wherein the rib portion extends in the height direction of the accommodation case such that the rib portion is located below than a lower end of the support body.

15. The battery assembly according to claim 4, wherein the support body includes:
a first body layer forming an inner surface of the buffer space and connected to at least a portion of the rib portion; and
a second body layer surrounding the first body layer and forming an outer side face of the support body.

16. The battery assembly according to claim 15, wherein the first body layer and the second body layer include materials different from each other.

17. The battery assembly according to claim 1, wherein the insertion member includes a fire-resistant material.

18. A method of manufacturing a battery assembly, wherein the battery assembly includes a plurality of battery cells staked and arranged in a predetermined stacking direction; an accommodation body including an opening in an upper portion; and an accommodation cover connected to the accommodation body and covering the opening, the method comprising:
stacking the plurality of battery cells;
coupling the plurality of stacked battery cells to the accommodation cover;
inserting an insertion member including a buffer space into an insertion space formed between lead tap portions of the plurality of battery cells; and
coupling the accommodation body to the accommodation cover.

19. The method of claim 18, further comprising, between the coupling of the plurality of stacked battery cells to the accommodation cover and the inserting of the insertion member,
a first inverting process of inverting the accommodation cover and the plurality of battery cells coupled to the accommodation cover.

20. The method of claim 19, further comprising, after the connecting of the accommodation body to the accommodation cover,
a second inverting process of inverting the accommodation cover and the accommodation body such that the accommodation cover is located above the accommodation body.
